(19) United States
(12) Patent Application Publication
(10) Pub. No.: US 2020/0097928 A1
(43) Pub. Date: Mar. 26, 2020

(54) SYSTEMS AND METHODS FOR CONDUCTING ACCOUNT TOKENIZED TRANSACTIONS

(71) Applicant: JPMORGAN CHASE BANK, N.A., New York, NY (US)

(72) Inventors: Andrew M. DRESNER, Larchmont, NY (US); Rebecca Sloan NEWMAN, Brooklyn, NY (US); Anum AFZAAL, Brooklyn, NY (US); Joe HUSSEY, Tampa, FL (US); Amy M. LESLIE, Ann Arbor, MI (US)

(21) Appl. No.: 16/576,982

(22) Filed: Sep. 20, 2019

Related U.S. Application Data
(60) Provisional application No. 62/734,301, filed on Sep. 21, 2018.

(51) Int. Cl. G06Q 20/08; G06Q 20/36; G06Q 20/02

(52) U.S. Cl. CPC G06Q 20/0855; G06Q 20/023; G06Q 20/3672

(57) ABSTRACT

Systems and methods for conducting account tokenized transactions are disclosed. In one embodiment, a method may include: receiving a third-party identifier, login credentials for a user, and an identification of a user account to tokenize from a trusted party; generating a token for the user account and associating the token with the user account and the third-party identifier; providing the token, a token-specific routing number, and the third-party identifier to the trusted party; receiving, from the third party's financial institution, a transaction comprising the token, the token-specific routing number, and the third-party identifier; identifying the transaction as involving a tokenized account based on the token-specific routing number; verifying that the third-party identifier received from the third party's financial institution matches the third-party identifier associated with the token; identifying the account associated with the token; posting the transaction to the account; and settling the transaction with the third party.

### RELATED APPLICATIONS

This application claims the benefit of U.S. Provisional Patent Application Ser. No. 62/734,301, filed Sep. 21, 2018, the disclosure of which is hereby incorporated by reference in its entirety.

### BACKGROUND OF THE INVENTION

### 1. Field of the Invention

Embodiments are directed to systems and methods for conducting account tokenized transactions.

### 2. Description of the Related Art

As the number of data aggregators grow, a financial institution's customers' account numbers are often disbursed to a large number of Financial Technology (FinTech) companies. This puts the customers at an increased risk for fraud.

### SUMMARY OF THE INVENTION

Systems and methods for conducing account tokenized transactions are disclosed. In one embodiment, in a financial institution information processing apparatus comprising at least one computer processor, a method for conducting account tokenized transactions may include: (1) receiving, from a trusted party, a third-party identifier for a third party, login credentials for a user, and an identification of a user account to tokenize; (2) generating a token for the user account and associating the token with the user account and the third-party identifier; (3) providing the token, a token-specific routing number, and the third-party identifier to the trusted party; (4) receiving, from a financial institution for the third party, a transaction comprising the token, the token-specific routing number, and the third-party identifier; (5) identifying the transaction as involving a tokenized account based on the token-specific routing number; (6) verifying that the third-party identifier received from the financial institution for the third party matches the third-party identifier associated with the token; (7) identifying the account associated with the token; (8) posting the transaction to the account; and (9) settling the transaction with the third party.

In one embodiment, the trusted party may be an aggregator.

In one embodiment, the third-party identifier may be an ACH Company ID.

In one embodiment, the token may include the token-specific routing number.

In one embodiment, the user account may be one of a DDA account or a line of credit account.

In one embodiment, the token-specific routing number may identify the account as a DDA account or a line of credit account.

In one embodiment, the token may include a plurality of alphanumeric characters, and has the same last four digits as the account.

In one embodiment, the transaction may include an ACH debit or an ACH credit transaction.

According to another embodiment, a system for conducting account tokenized transactions may include a backend for a financial institution comprising at least one computer processor, the financial institution associated with a user; a trusted party; a third party; and a financial institution associated with the third party. The third party may be configured to provide the trusted party with a third-party identifier and engages the trusted party to interface with the financial institution associated with the user to obtain a token for a user account. The financial institution associated with a user may be configured to receive the third-party identifier and an identifier for the user account from the trusted party, to generate the token for the user account and to associate the token with the user account and the third-party identifier, and to provide the token, a token-specific routing number, and the third-party identifier to the trusted party. The trusted party may be configured to provide the token, a token-specific routing number, and the third-party identifier to the third party. The third party may be configured to initiate a transaction using the token, a token-specific routing number, and the third-party identifier and to provide transaction to the financial institution associated with the third party. The financial institution associated with the third party may be configured to provide the transaction comprising the token, the token-specific routing number, and the third-party identifier to the financial institution associated with a user, to identify the transaction as involving a tokenized account based on the token-specific routing number, to verify that the third-party identifier received from the financial institution for the third party matches the third-party identifier associated with the token, to identify the account associated with the token, to post the transaction to the account, and to settle the transaction with the third party.

In one embodiment, the third party may be configured to receive, from the user, authorization to access the user account at the user's financial institution.

In one embodiment, the trusted party may be an aggregator.

In one embodiment, the third-party identifier may be an ACH Company ID.

In one embodiment, the token may include the token-specific routing number.

In one embodiment, the user account may be one of a DDA account or a line of credit account.

In one embodiment, the token-specific routing number may identify the account as a DDA account or a line of credit account.

In one embodiment, the token may include a plurality of alphanumeric characters, and has the same last four digits as the account.

In one embodiment, the transaction may be an ACH debit or an ACH credit transaction.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for conducting account tokenized transactions according to one embodiment; and

FIG. 2 depicts a method for conducting account tokenized transactions according to one embodiment.

### DETAILED DESCRIPTION OF PREFERRED EMBODIMENTS

Embodiments are generally directed to systems and methods for conducting account tokenized transactions. In embodiments, a customer's account numbers for transactions may be tokenized for transactions, such as ACH pull transactions.

In embodiments, customer account numbers are not distributed to third parties. Moreover, in embodiments, no adjustments in the transactions are required. Further, customers may “turn off” access for one third party without having to change or reissue the underlying account number.

In embodiments, when a financial institution's customer authorizes a third party (e.g., a FinTech) access to their accounts with the financial institution, embodiments may create a token for the customer's account number from which the third party can execute a transaction, such as an ACH transaction. This token may be linked to the third party's identifier (generally unique to each third party, and a standard field in ACH transactions such as an ACH Company ID), and may be created in the format of a standard DDA account number, and is sent to aggregator along with a unique routing number (RT) for all tokens. The token may be distributed to the third party, which may use the token to initiate ACH pull debit transactions or ACH deposit credit transactions against the financial institution's customer's account.

In embodiments, when the financial institution receives the ACH request, the unique routing number may indicate to the financial institution that the transaction includes a tokenized account number. The token vault may then verify that the third-party ID matches the token, and the token may then be de-tokenized to reveal the true account number. The debit or credit may then be posted to the correct customer account, and the transaction proceeds as normal.

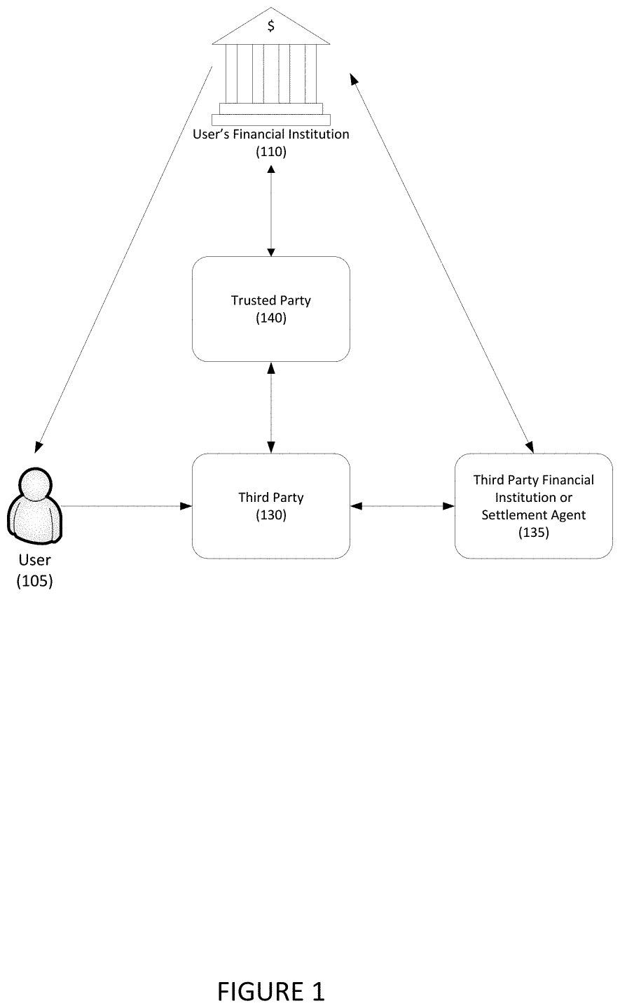

Referring to FIG. 1, a system for conducting account tokenized transactions is provided according to one embodiment. System 100 may include user 105, which may be an individual, a group of individuals, an organization, a company, etc.; user's financial institution 110; trusted party 140, such as an aggregator; third party 130 (e.g., a merchant, recipient of a transaction, etc.); and third party financial institution or settlement agent 135.

User 105 may, using an electronic device (not shown), authorize third party 130 to access banking account at user's financial institution 110 to facilitate one or more ACH transactions with third party 130. Third Party 130 may provide identifier (e.g., an ACH Company ID) to trusted party 140 and request trusted party 140 access user 105's account information at user's financial institution 110. A backend for user's financial institution 110 may generate a token and provide the token, a token specific routing number as well as a third-party identifier to trusted party 140, which may provide the same to third party 130. Third party 130 may provide ACH transaction information related to user 105 including the token, the token specific routing number and the third party identifier to the third party financial institution or settlement agent 135, which may provide the transaction information, the token, and the third-party identifier to user's financial institution 110, which may then post the transaction to the user 105 account and settle the transaction (through ACH clearing channels) with third party's financial institution or settlement agent 135.

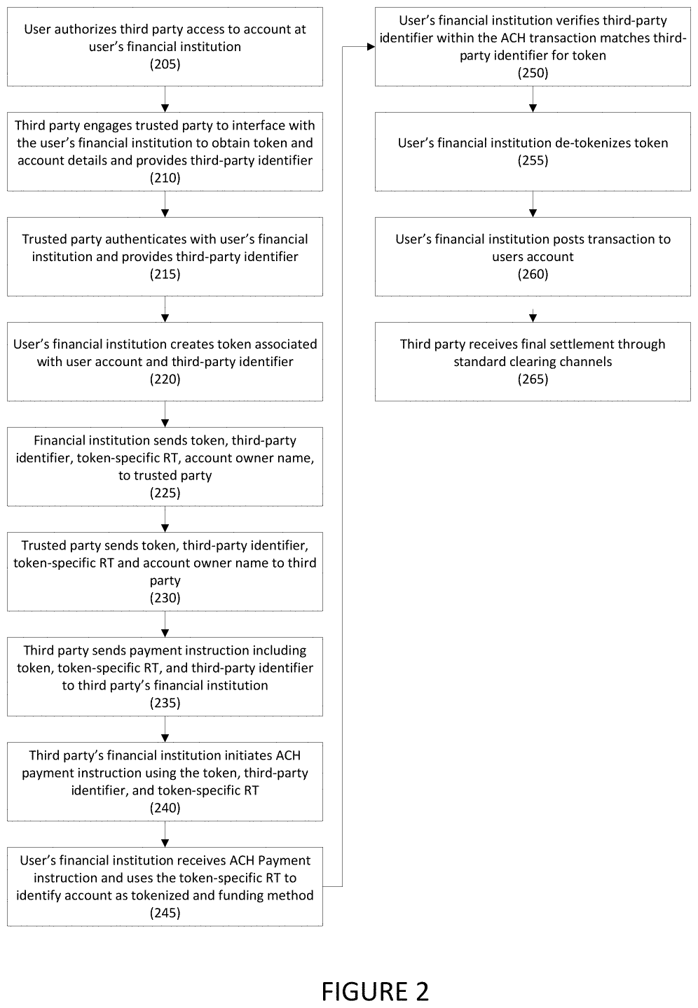

Referring to FIG. 2, a method for conducting account tokenized transactions is disclosed according to one embodiment.

In step 205, a user may authorize a third party (e.g., a merchant, a recipient of a transaction, etc.) with access to a user account with a financial institution. For example, the user may provide the third party with the user's login credentials to the user's financial institution. In one embodiment, the user may further select whether the user would like to pay using the user's DDA account, a line of credit account, an alternate payment currency (e.g., pay with points), etc.

In step 210, the third party may engage the trusted party to interface with the user's financial institution to obtain token and account details and may provide the trusted party with the third-party identifier (e.g., the third party's ACH Company ID).

In step 215, the trusted party may provide a backend for the user's financial institution with the identification of the third party (e.g., an ACH company ID), the user's login credentials for the user's financial institution (e.g., user ID and password), and the identification of a user account. In one embodiment, the trusted party may use an API to provide this information.

In step 220, the user's financial institution may create a token and may associate that token with the user account (e.g., DDA, LOC, etc.) and may link the token to the third-party identifier. In one embodiment, the account token may have a standard DDA account number format, and may use a unique routing (RT) number. For example, the user's financial institution may use one RT number for DDA-provisioned end users, and a different RT for LOC-provisioned end users. Other ways of using RT numbers may be used as is necessary and/or desired.

In embodiments, the token may be housed at the financial institution, at a token service provider (e.g., TCH), etc.

In one embodiment, the account token may have the same last four digits as the DDA or LOC account number. In another embodiment, users may be provided with a token-like experience for tokens so that they can view their account tokens on file.

In step 225, the user's financial institution may provide the token, the third-party identifier, and the account specific RT to the trusted party. In one embodiment, the user's financial institution may further provide the account owner name and the account balance and/or the available credit for the account.

In step 230, the trusted party may provide the token, the account specific RT, and the third-party identifier to the third party. In one embodiment, the trusted party may further provide the account owner name and the account balance and/or available credit for the account. The trusted party may provide the third party with any other information as is necessary and/or desired.

In step 235, the third party may send a payment instruction (e.g., an ACH payment instruction) including the token, the token-specific RT, and the third-party identifier to the third party's financial institution or settlement agent.

In step 240, the third party's financial institution may initiate a transaction (e.g., an ACH debit or an ACH credit transaction) using the token, the third-party identifier, and the token-specific RT provided. In one embodiment, the third-party identifier may be provided in a field of the ACH transaction.

In step 245, the user's financial institution may use the token-specific RT to identify that the transaction involves a tokenized account, and to identify the funding method.

For example, when the debit or credit arrives at the user's financial institution, it may be sorted according to RT, which may identify the source (e.g., DDA, LOC, etc.).

In step 250, the user's financial institution may verify the third-party identifier in the ACH matches the third-party identifier that is associated with the token. If the third-party identifiers do not match, the transaction may be rejected.

In step 255, the user's financial institution may de-tokenize the token by identifying the account(s) that are associated with the token.

In step 260, the user's financial institution may debit or credit the account associated with the token and, in step 265, may settle and clear the transaction with the third party via, for example, the Federal Reserve Bank.

Although multiple embodiments have been disclosed, it should be recognized that these embodiments are exemplary only and features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for conducting account tokenized transactions, comprising:
in a financial institution information processing apparatus comprising at least one computer processor:
receiving, from a trusted party, a third-party identifier for a third party, login credentials for a user, and an identification of a user account to tokenize;
generating a token for the user account and associating the token with the user account and the third-party identifier;
providing the token, a token-specific routing number, and the third-party identifier to the trusted party;
receiving, from a financial institution for the third party, a transaction comprising the token, the token-specific routing number, and the third-party identifier;
identifying the transaction as involving a tokenized account based on the token-specific routing number;
verifying that the third-party identifier received from the financial institution for the third party matches the third-party identifier associated with the token;
identifying the account associated with the token;
posting the transaction to the account; and
settling the transaction with the third party.

2. The method of claim 1, wherein the trusted party comprises an aggregator.

3. The method of claim 1, wherein the third-party identifier is an ACH Company ID.

4. The method of claim 1, wherein the token comprises the token-specific routing number.

5. The method of claim 1, wherein the user account comprises one of a DDA account or a line of credit account.

6. The method of claim 1, wherein the token-specific routing number identifies the account as a DDA account or a line of credit account.

7. The method of claim 1, wherein the token comprises a plurality of alphanumeric characters, and has the same last four digits as the account.

8. The method of claim 1, wherein the transaction comprises an ACH debit or an ACH credit transaction.

9. A system for conducting account tokenized transactions, comprising:
a backend for a financial institution comprising at least one computer processor, the financial institution associated with a user;
a trusted party;
a third party; and
a financial institution associated with the third party;
wherein:
the third party is configured to provide the trusted party with a third-party identifier and engages the trusted party to interface with the financial institution associated with the user to obtain a token for a user account;
the financial institution associated with a user is configured to receive the third-party identifier and an identifier for the user account from the trusted party;
the financial institution associated with the user is configured to generate the token for the user account and to associate the token with the user account and the third-party identifier;
the financial institution associated with a user is configured to provide the token, a token-specific routing number, and the third-party identifier to the trusted party;
the trusted party is configured to provide the token, a token-specific routing number, and the third-party identifier to the third party;
the third party is configured to initiate a transaction using the token, a token-specific routing number, and the third-party identifier and to provide transaction to the financial institution associated with the third party;
the financial institution associated with the third party is configured to provide the transaction comprising the token, the token-specific routing number, and the third-party identifier to the financial institution associated with a user;
the financial institution associated with a user is configured to identify the transaction as involving a tokenized account based on the token-specific routing number;
the financial institution associated with a user is configured to verify that the third-party identifier received from the financial institution for the third party matches the third-party identifier associated with the token;
the financial institution associated with a user is configured to identify the account associated with the token;
the financial institution associated with a user is configured to post the transaction to the account; and
the financial institution associated with a user is configured to settle the transaction with the third party.

10. The system of claim 9, wherein the third party is configured to receive, from the user, authorization to access the user account at the user's financial institution.

11. The system of claim 9, wherein the trusted party comprises an aggregator.

12. The system of claim 9, wherein the third-party identifier is an ACH Company ID.

13. The system of claim 9, wherein the token comprises the token-specific routing number.

14. The system of claim 9, wherein the user account comprises one of a DDA account or a line of credit account.

15. The system of claim 9, wherein the token-specific routing number identifies the account as a DDA account or a line of credit account.

16. The system of claim 9, wherein the token comprises a plurality of alphanumeric characters, and has the same last four digits as the account.

17. The system of claim 9, wherein the transaction comprises an ACH debit or an ACH credit transaction.
